(19) United States
(12) Patent Application Publication
(10) Pub. No.: US 2003/0209403 A1
(43) Pub. Date: Nov. 13, 2003

(54) Method and process for loading and unloading parts

(76) Inventor: Evan R. Daniels, Dallas, TX (US)

Correspondence Address: HAYNES AND BOONE, LLP, 901 MAIN STREET, SUITE 3100, DALLAS, TX, 75202, US

(21) Appl. No.: 10/144,459

(22) Filed: May 13, 2002

(51) Int. Cl. B65G 49/00

(52) U.S. Cl. 198/341.05

(57) ABSTRACT

The present invention is a method for loading parts onto a work table that has the step of conveying parts to a work table by a conveyor. The work table has a plurality of rows, each having a plurality of locations. One part is transferred to each of the plurality of locations on the rows. Each one of the parts at each of the plurality of the locations is located with reference to a known coordinate system. The parts are then releasably fixed to the work table.

The present invention relates to performing operations on a part and, more particularly to, an improved method and process for loading parts on a worktable to perform subsequent manufacturing operations on the parts and unloading the parts after the manufacturing operations are performed.

### BACKGROUND OF THE INVENTION

Many manufacturing facilities depend on producing high volumes of products to be competitive in a particular industry. In most high volume manufacturing, higher rates of production yield proportionately higher profits. Additionally, higher production rates may also increase market share, which, in turn, directly increases the profitability of the manufacturing facility. Increasing the flow of parts supplied to fabrication equipment is one technique that may increase production rates.

Supplying raw materials or parts to fabrication equipment is commonly known as materials handling. Various material handling devices and systems are known that lift and carry parts from one station to another, such as endless belt conveyors and shuttle-type transfer mechanisms. In multiple station transfer lines with multiple work stations spaced along the line, parts are typically received on locators therein and a transfer shuttle mechanism is provided for lifting and carrying parts from one station to another.

Usually, the part carrier or “live” rails of the shuttle travel in a closed loop rectangular travel path disposed in a vertical plane with the lower horizontal or retraction path leg or run oriented to underlie all of the parts. The entire shuttle is raised and lowered generally vertically in this plane by suitable elevator mechanisms actuated by a drive mechanism which in operation raises the shuttle to lift the parts on the live rails generally vertically above the stationary locators, whereupon the shuttle live rails are actuated by a synchronized horizontal reciprocating drive mechanism to advance the parts along a horizontal run of the travel path of the shuttle. Then the elevators are lowered to move the entire shuttle generally vertically downwardly to deposit the advanced parts individually in the next successive work stations. After such part placement the elevators further lower the shuttle sufficiently to disengage and clear the parts, and the live rails are then retracted along the lower horizontal run of their travel path to reposition the shuttle for the next transfer cycle.

Such shuttle-type transfer mechanisms are preferred, and indeed required, in many processing lines over endless belt, chain or other type systems for conveying parts even though the latter may be less expensive in construction and capable of faster conveying speeds. Shuttle-type transfer mechanisms are unique in having lift and carry functions which can be precisely synchronized with the various work cycles of the multiple stations in a processing line to provide, at predetermined precise locations and with split second timing, accurate positioning of the individual parts being transferred along the processing line. Thus, by utilizing a shuttle-type transfer line, each part can be intermittently advanced and then held stationary while located precisely at a known position at a known point in time, and the various station work cycles thereby precisely coordinated with parts in an intermittent conveying process. This characteristic of shuttle-type transfer mechanisms renders them highly suited for high speed automated processing lines, particularly those where computer controlled and programmed robotic or other automated mechanisms are employed as adjuncts to the work being carried out in the processing line.

For example, high speed repetitive progressive die transfer press sheet metal stamping operations are conventionally employed to impart by progressive stamping the finished curvature and other features into automotive body door panels. The press is operated through its reciprocating work stroke stamping cycle as the blanks are advanced through the progressive dies of the press, and the internal press transfer mechanism and/or a separate press unloader operates rapidly to individually remove each finished stamping one at a time in a very short cycle, which may be on the order of 2 to 4 seconds. Although a typical endless-loop-type conveyor can receive the finished stampings from the press unloader at an operating rate which can keep up with such a rapid work cycle so as to transport a line array of the finished door panels downstream to a gang of unloading stations, the manual operation of unloading the stampings from the downstream end of such a conveyor usually requires a crew of several unloading workmen in order to keep up with the conveyor delivery speed at the conveyor unloading stations.

An automated single robotic unloader has not been available to do this job because its cycle time is too great. The conveyor part unloading cycle requires that the finished stamping be engaged or gripped while on the conveyor, then lifted off of the conveyor, then carried to a storage rack while manipulating the part, usually through a 90.degree. bodily rotation, and then located in a storage slot compartment in a multiple part transit container. After the part is so stored and released, the part unloader must continue to cycle back to the conveyor to pick up the next body panel stamping. The total time of this conveyor unload cycle thus greatly exceeds the rate at which the body stamping parts need to be loaded onto and advanced by the conveyor.

Even using a gang of automated robot unloading mechanisms for simultaneously gang unloading a fast moving conventional conveyor does not solve the problem. Generally, robot unloaders have not been commercially developed to a state where they can reliably rapidly find or locate parts carried on an endless belt conveyor, even when intermittently operated, much less when the mode of operation produces continuous movement of the parts on the conveyor. Rather, to achieve safe, reliable and efficient automated unloading operations, robotic unloading mechanisms need the accurate synchronization provided by a shuttle-type transfer mechanism such that the part stampings are reliably and accurately delivered to an unloading station, held immobile in a dwell phase of the cycle at a precise location at a given point of time in the work cycle, and for a precise predetermined period of time to thereby enable the robot to find, securely engage and lift the part off and out of the unload station.

Although shuttle-type transfer systems and robotic unloaders are thus highly compatible for use in automated processing lines, conventional shuttle-type transfer mechanisms inherently impose another cycle rate limitation. Due to their aforementioned inherent closed loop shuttle mode of travel motion, there is a minimum finite cycle time required for the typical shuttle mechanism to move through its rectangular travel path in a vertical plane to accomplish the sequence of (1) engaging the part, (2) lifting the same, (3) carrying the part on an advance stroke, (4) lowering the part onto a fixed locator, (5) continuing to lower to the clearance position and then (5) moving on its retraction stroke back to the pickup position in its path. The minimum duration of this cycle is limited by such factors as the horizontal and vertical stroke distances needed, the mass of the moving parts of the transfer shuttle mechanism itself and the mass of the total part load being carried by the transfer shuttle, all of which must be respectively accelerated, decelerated and held stationary, the need to smoothly and rapidly transfer parts both vertically and horizontally without jarring, shocking or mis-locating them, and the limitations of the power drive train components. All of these factors constrain the maximum operating speed and hence minimum cycle time achievable with a conventional shuttle-type transfer mechanism.

It would, therefore, be desirable to have an improved method of loading and unloading parts that does not require the time or human intervention of currently available systems.

### SUMMARY OF THE INVENTION

The present invention is a method for loading parts onto a work table that has the step of conveying parts to a work table by a conveyor. The work table has a plurality of rows, each having a plurality of locations. One part is transferred to each of the plurality of locations on the rows. Each one of the parts at each of the plurality of the locations is located with reference to a known coordinate system. The parts are then releasably fixed to the work table.

In one embodiment of the invention, a method of loading parts onto a work table has the steps of conveying each of the multiple parts to a loading location. Each of the multiple parts is then transferred to a predetermined location on a work table and releasably fixed to the predetermined location. An operation is then performed on each of the multiple parts.

### BRIEF DESCRIPTION OF THE DRAWINGS

For a more complete understanding of the present invention, including its features and advantages, reference is now made to the detailed description of the invention, taken in conjunction with the accompanying drawings of which:

FIG. 1 is a schematic view of a parts loader that depicts an embodiment of the present invention; and

FIG. 2 is detail view of a located part that depicts an embodiment of the present invention.

### DETAILED DESCRIPTION OF THE INVENTION

While the making and using of various embodiments of the present invention is discussed in detail below, it should be appreciated that the present invention provides many applicable inventive concepts that can be embodied in a wide variety of specific contexts. The specific embodiments discussed herein are merely illustrative of specific ways to make and use the invention, and do not delimit the scope of the invention.

A method of loading parts according to one embodiment of the present invention has many desirable features that were previously unavailable to those in the business of automated manufacturing systems. Although methods for loading parts are known, efficiently locating parts presented several problems such as the difficulty of precisely orienting parts for subsequent manufacturing operations.

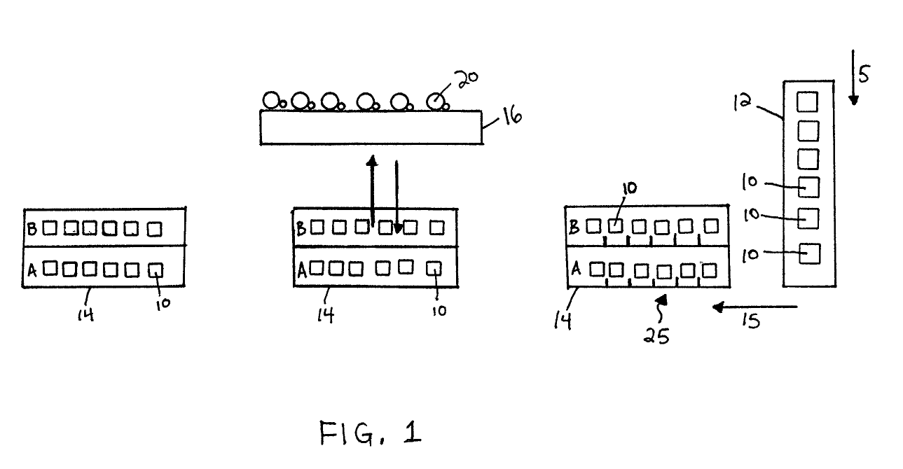

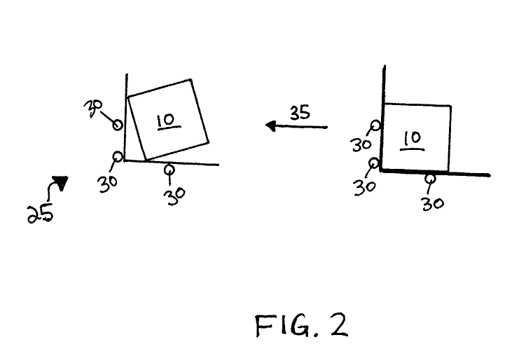

Referring now to the figures and, in particular to FIG. 1, multiple parts 10 are conveyed in a first direction 5 by a conveyor 12 to a work table 14. The parts 10 may then be transferred in direction 15, which may be approximately normal to direction 5, on to the work table 14. Work table 14 may have a plurality of rows A, B, which have a plurality of locations 25. Each location 25 may have one or more locating features 30, which are described in greater detail with reference to FIG. 2, below. After each of the parts 10 are loaded into each of the locations 25 on the work table 14, the parts 10 are oriented with reference to a known coordinate system. The parts 10 may then be releasably fixed by vacuum or other known method of releasably fixing parts known by those having ordinary skill in the art.

The work table 14 is then automatically moved to a work station 16. The work station 16 may have one or more machines 20, such as routers, sanders and the like, to perform manufacturing operations on each of the parts 10. The work station 16 may have one machine 20 for each location 25 on the work table 14. The machines 20 may be controlled by Computer Numerical Control (CNC) or other method of automatically performing operations on parts known to those having ordinary skill in the art.

After a particular operation is performed on the parts 10, the work table 14 may be removed from the work station 16 and moved to a subsequent manufacturing operation such as sanding, finishing and the like. After all desired manufacturing operations have been performed on the parts 10, the parts may be released from the locations 25 and unloaded.

Turning now to FIG. 2, a location 25 to orient the part 10 has one or more locating features 30. The locating features 30 engage one or more surfaces of the part 10 to precisely orient the part 10 according to a known coordinate. The part 10 may be urged into alignment by a force in a direction generally designated by arrow 35. The force may be automatically applied linearly or by vibration. The force causes one or more surfaces of the part 10 to engage the locating features 30 and, as a result, the part 10 becomes oriented in a desired position. The position of the part 10 may be checked by laser or other method of determining orientation known by those having ordinary skill in the art. After the position of the part 10 is confirmed, the part 10 may be releaseably fixed in the desired position by a vacuum or other method known by those having ordinary skill in the art. Subsequent manufacturing processes may then be performed on the part 10.

Whereas the invention has been shown and described in connection with the preferred embodiment thereof, it will be understood that many modifications, 15 substitutions and additions may be made which are within the intended broad scope of the appended claims. There has therefore been shown and described an improved powder coating system that accomplishes at least all of the above stated advantages.

What is claimed is:

1. A method for loading parts onto a work table comprising the steps of:
conveying parts to a work table by a conveyor, the work table having a plurality of rows, the plurality of rows each having a plurality of locations;
transferring one part to each of the plurality of locations;
locating each one of the parts at each of the plurality of the locations with reference to a known coordinate system; and
releasably fixing each of the parts to the work table.

2. The method of claim 1, wherein the parts made from particleboard.

3. The method of claim 1, wherein the parts are made from medium density fiberboard.

4. The method of claim 1, wherein releasably fixing each of the parts is by a vacuum.

5. The method of claim 1, wherein locating each one of the parts is by one or more pins.

6. The method of claim 1, further comprising the step of introducing the work table and the parts to a work station.

7. The method of claim 6, wherein the work station has one or more routers.

8. The method of claim 6, wherein the work station has one or more sanders.

9. The method of claim 6, further comprising the step of introducing the work table and the parts to a finishing station.

10. The method of claim 6, further comprising the step of unloading the parts from the work table.

11. The method of claim 10, wherein the step of unloading the parts from the worktable is unloading the parts generally simultaneously.

12. The method of claim 10, wherein the step of unloading the parts from the worktable is by an automated machine.

13. A process for performing operations on multiple parts comprising the steps of:
conveying each of the multiple parts to a loading location;
transferring each of the multiple parts to a predetermined location on a work table;
releasably fixing each of the multiple parts to the predetermined location; and
performing an operation on each of the multiple parts.

14. The process of claim 13, wherein performing an operation on each of the multiple parts is with a router.

15. The process of claim 13, wherein performing an operation on each of the multiple parts is with a sander.

16. The process of claim 13, wherein each of the multiple parts is wood.

17. The process of claim 13, wherein each of the multiple parts is particleboard.

18. The process of claim 13, wherein each of the multiple parts is medium density fiberboard.

19. The process of claim 13, further comprising the step of automatically unloading each of the multiple parts from the work table.

20. The process of claim 19, wherein the step of automatically unloading each of the multiple parts from the work table is by a robot.
